(19) United States
(12) Patent Application Publication
(10) Pub. No.: US 2013/0051184 A1
(43) Pub. Date: Feb. 28, 2013

(54) REAL-TIME CLOCK INTEGRATED CIRCUIT WITH TIME CODE RECEIVER, METHOD OF OPERATION THEREOF AND DEVICES INCORPORATING THE SAME

(71) Applicants: Oren Eliezer, Plano, TX (US); Thomas Jung, Dallas, TX (US); Steve Morrison, Plano, TX (US); Mary Cooley, Plano, TX (US)

(72) Inventors: Oren Eliezer, Plano, TX (US); Thomas Jung, Dallas, TX (US); Steve Morrison, Plano, TX (US); Mary Cooley, Plano, TX (US)

(21) Appl. No.: 13/297,768

(22) Filed: Nov. 16, 2011

Related U.S. Application Data
(60) Provisional application No. 61/527,979, filed on Aug. 26, 2011.
(60) Provisional application No. 61/527,998, filed on Aug. 26, 2011.

(51) Int. Cl. G04C 11/02; G04C 11/00

(52) U.S. Cl. 368/47; 368/200

(57) ABSTRACT

An integrated circuit (IC), a method of operating the IC and devices incorporating the IC. In one embodiment, the IC includes: (1) a monolithic substrate and (2) a time code receiver supported by the monolithic substrate and configured to receive a timing signal and employ the timing signal to adjust a local oscillator of a real time clock (RTC).

### CROSS-REFERENCE TO RELATED APPLICATION

This application claims the benefit of U.S. Provisional Application Ser. No. 61/527,979, filed by Eliezer, et al., on Aug. 26, 2011, entitled “Real Time Clock with Integrated Time Code Receiver” and U.S. Provisional Application Ser. No. 61/527,998, filed by Eliezer, et al., on Aug. 26, 2011, entitled “Radio-Synchronized Clock Receiver Chip with Phase Modulation in Appliances and Vehicles”, both commonly assigned with this application and incorporated herein by reference. This application is also related to PCT Patent Application Serial No. PCT/US11/52770, filed by Eliezer, et al., on Sep. 22, 2011, entitled “Low Power Radio Controlled Clock Incorporating Independent Timing Corrections,” and U.S. application Ser. No. 13/240,615, filed by Eliezer, et al., on Sep. 22, 2011, entitled “Low Power Radio Controlled Clock Incorporating Independent Timing Corrections,” and U.S. patent application Ser. No. 13/291,708, filed by Eliezer, et al., on Nov. 8, 2011, entitled “Mixed Signal Integrator Incorporating Extended Integration Duration,” both commonly assigned with this application and incorporated herein by reference.

### TECHNICAL FIELD

This application is directed, in general, to integrated circuits (ICs) and, more specifically, to a real-time clock IC with a time code receiver, a method of operation thereof and devices incorporating the same.

### BACKGROUND

Embedded systems rely on real time clocks (RTCs) or real time clock-calendars (RTCCs) to schedule events and measure durations. (“RTC” will be used hereinafter as a generic term to encompass both RTCs, which lack a calendar function, and RTCCs.) RTCs are so important that they are typically left powered on even when devices enter lower power modes in which other circuit is shut down to extend battery life and reduce power consumption. Because RTCCs contain calendar information that cannot be internally reconstructed, they typically have battery backups that keep them operational when their main power source is unavailable.

RTCs use a local frequency reference to keep track of time. Often a 32 kHz crystal oscillator with an initial accuracy of ±20 ppm is used as the local frequency reference. The 32 kHz frequency is currently favored as a compromise among accuracy, cost and power consumption. Unfortunately, the oscillator frequency and corresponding accuracy of RTCs change over time as a result of temperature and power supply variations and the crystals age. Left uncorrected, the clock signal provided by an RTC become increasingly erroneous as accuracy degrades.

### SUMMARY

One aspect provides an IC. In one embodiment, the IC includes: (1) a monolithic substrate and (2) a time code receiver supported by the monolithic substrate and configured to receive a timing signal and employ the timing signal to adjust a local oscillator of an RTC.

Another aspect provides a method of operating an IC. In one embodiment, the method includes: (1) receiving a phase-modulated timing signal from WWVB into a time code receiver supported by a monolithic substrate and (2) employing the timing signal to adjust a local oscillator of an RTC.

Yet another aspect provides a device. In one embodiment, the device includes: (1) an IC having: (1a) a monolithic substrate and (2) time code receiver supported by the monolithic substrate and configured to receive a timing signal and employ the timing signal to adjust a local oscillator of an RTC, (2) a controller, (3) a user interface, (4) other device hardware, firmware or software and (5) a bus coupling the IC, the controller, the user interface and the other device hardware, firmware or software.

### BRIEF DESCRIPTION

Reference is now made to the following descriptions taken in conjunction with the accompanying drawings, in which:

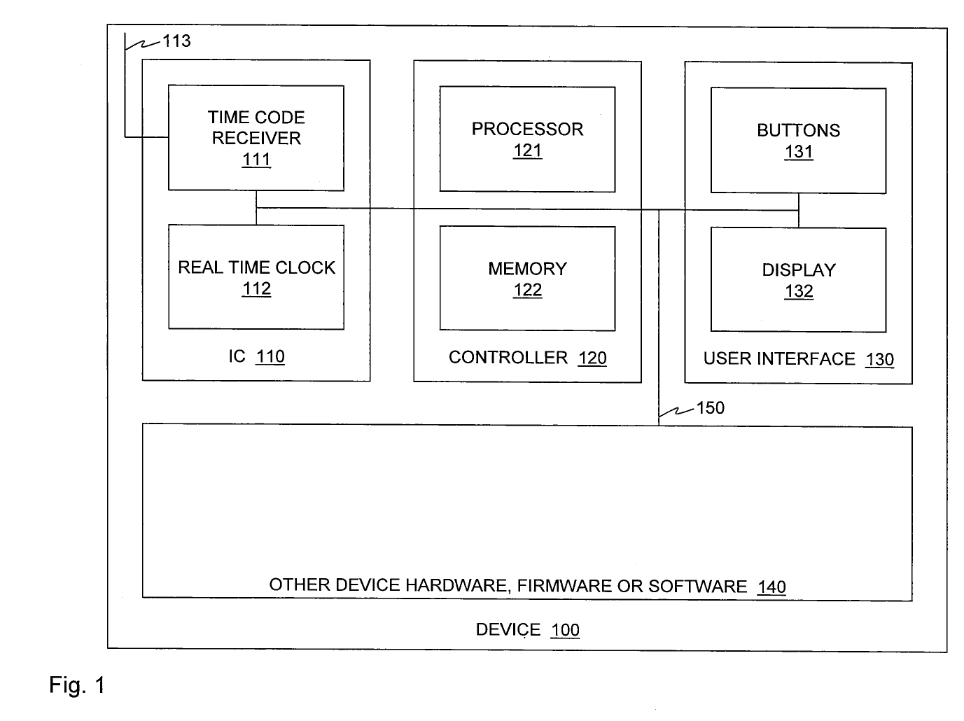

FIG. 1 is a block diagram of one embodiment of a device including an IC having a time code receiver; and

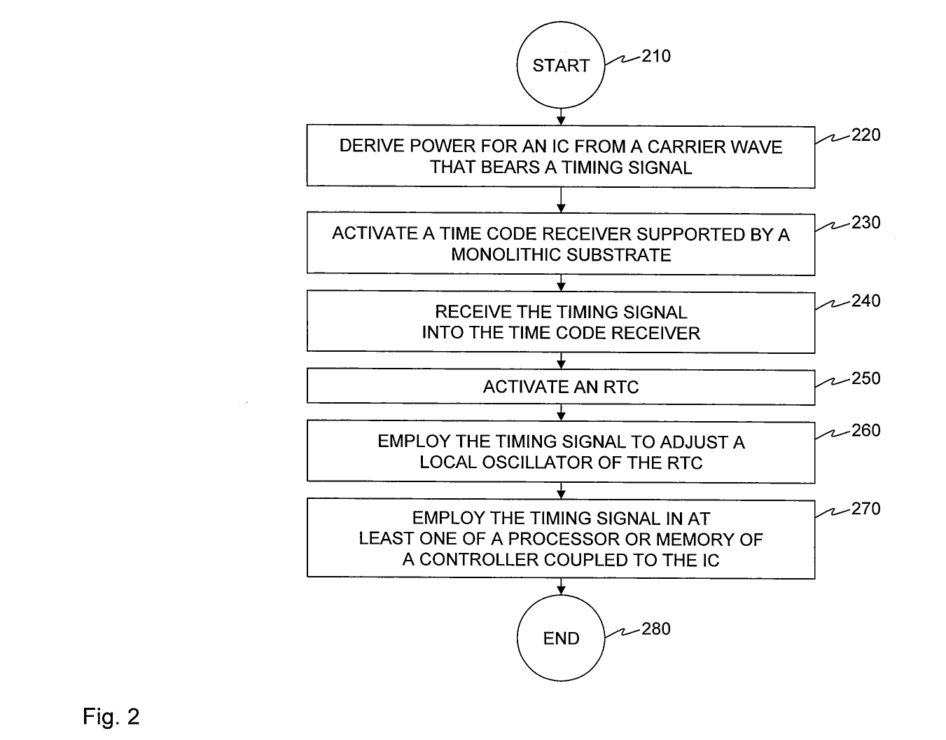

FIG. 2 is a flow diagram of one embodiment of a method of operating an IC having a time code receiver.

### DETAILED DESCRIPTION

Many industrial applications require a precise time reference, frequency reference, or both, to operate properly. Telecommunications networks, cellular phone networks and power grids are some examples. As confirmed in Lombardi, “Comparing LORAN Timing Capability to Industrial Requirements,” 35^{th} Annual ILA Conference, Groton, Conn., October 2006, http://tf.nist.gov/general/pdf/2193.pdf, current industrial requirements are ±1 μs for time accuracy and ±1×10⁻¹¹ for frequency accuracy to Coordinated Universal time (UTC). These requirements are met by Stratum-1 clock sources.

The National Institute of Standards and Technology (NIST) broadcasts an amplitude modulated timing signal on a low frequency radio station having the call letters “WWVB.” Because NIST employs a Cesium-based atomic clock to drive its timing signal, the NIST timing signal is colloquially referred to as an “atomic clock.” It is accordingly very accurate, having a frequency accuracy of ±5×10⁻¹² (supra). However, because the signal is amplitude modulated and broadcast at 60 kHz, it is limited to a received time accuracy of ±100 μs. Ironically, while NIST's WWVB atomic clock timing signal meets the Stratum-1 frequency requirement, it does not meet the time accuracy requirement. Other time code transmitters around the world (e.g., JJY in Japan, DCF77 in Germany and GBZ in Great Britain) broadcast time and frequency information as well, but also fail to meet both Stratum-1 time and frequency requirements.

NIST is now upgrading WWVB to overlay phase modulation on its amplitude modulation. The resulting NIST timing signal has a significantly improved time accuracy, allowing receivers of the WWVB signal to meet the ±1 μs industrial time accuracy requirement, in addition to the frequency requirement.

Conventional WWVB receivers have significant antenna sensitivity and directionality issues, which has limited the use of such receivers to devices that are routinely moved or repositioned to allow such receivers to receive the WWVB broadcast. Various embodiments of an IC containing a time code receiver capable of receiving time and frequency information from the improved phase-modulated NIST timing signal can now be applied to a wide array of devices, including small appliances, larger, stationary appliances, automobiles, trucks and commercial vehicles, in the absence of Internet or GPS or other global navigation satellite system (GNSS) connectivity. Outfitted with accurately synchronized clocks, consumers can reliably program their appliances to operate when they wish for energy management or personal convenience reasons. Further, any displays on the devices configured to display clock or calendar information will reflect the correct information. Consumers are therefore relieved of the task of adjusting time due to power failure or commonly-experienced clock drift or daylight savings time (DST) changes.

It is therefore recognized herein that many applications, including embedded systems, would benefit from an improved RTC. It is further recognized herein that many applications would benefit from an RTC capable of employing time and frequency information received from WWVB or perhaps other time code transmitters continually to adjust, or “discipline,” its local oscillator. It is still further recognized herein that, because the revised NIST timing signal employs phase modulation, a time code receiver can be constructed in an IC on a monolithic substrate, which is not possible using the components required to receive and decode an amplitude-modulated signal at the 60 kHz transmission frequency. The resulting IC would typically be small and inexpensive and therefore able to be included in a host of embedded systems and devices in general that have never before benefited from the availability of a far more accurate RTC. Therefore, it is recognized herein that many applications would benefit from an improved time code receiver, and perhaps an RTC integrated with the time code receiver, embodied in an IC.

Accordingly, described herein are various embodiments of an IC containing a time code receiver and a method of operating such an IC to provide an RTC function. Certain of these embodiments include an RTC on the same IC substrate. The time code receiver is configured to receive precise date and time information from a broadcast source such as WWVB. In certain embodiments, the time code receiver compares the precise date and time information to the frequency of the RTC's local oscillator and computes the error between the two. This error can be substantial, perhaps several seconds per day.

Accurate DST information is critical for the proper operation of certain heterogeneous networks of elements. Were all elements in a given network to be unaware of a change to or from DST, the network would likely continue to operate. However, if some elements were to be aware, and others not, scheduling and device coordination would likely fail to function as intended. Unfortunately, DST changes depend on government fiat and therefore cannot be reliably hard-coded into an RTC.

Therefore, in certain embodiments, the time code receiver is further configured to receive DST changes from a broadcast source such as WWVB. The certain embodiments of the time code receiver update the RTC when they occur so scheduling events and alarms that rely on absolute time (e.g., 9 AM, Monday) operate properly. In certain related embodiments, the time code receiver is still further configured to receive leap second, related Coordinated Universal Time (UTC) updates and other signaling information as may be received from a time code transmitter.

In certain embodiments the time code receiver is configured to be activated before the RTC and the circuitry to which the RTC is coupled (e.g., the remainder of an embedded system) is activated. Early activation of the time code receiver allows the RTC to be updated to reduce or perhaps remove any error. The circuitry to which the RTC is coupled can then be activated and provided the correct time and frequency by the RTC. Not only does this allow the RTC to be activated with the information in place to updated and the circuitry to which the RTC is coupled to be activated with a correct time and frequency reference in place, but overall power consumption can be reduced by activating the time code receiver, the RTC and the circuitry to which the RTC is coupled in this order.

In various embodiments, the time code receiver also provides traceability back to recognized standards, such as UTC(NIST) and UTC(USNO), which are the United States government's atomic clock time standards that NIST and the U.S. Naval Observatory (USNO) provide. This is important in certain applications in which embedded systems communicate across organizational or company boundaries.

In certain embodiments, the time code receiver and RTC are configured to operate autonomously from any controller with which they may be associated. In more specific embodiments, they are configured to operate autonomously based on a history of frequency errors estimated over time and a specified target accuracy. In related embodiments, the time code receiver is configured to operate to verify RTC performance occasionally or periodically, not only in regards to frequency drift but also to day, date, month and year calculations. In certain more specific embodiments, the time code receiver is configured to provide a signal, such as an interrupt, to the embedded system if it determines the RTC is inaccurate.

Various embodiments of the IC and method described herein are configured to be packaged such that it is pin-compatible, function-compatible, or both pin- and function-compatible with commercially available RTCs or RTCCs. In certain embodiments, the same pin on the IC can serve as an antenna pin (the pin configured to communicate with an antenna for the time code receiver) and a local oscillator pin (the pin configured to communicate with a local oscillator is coupled. In general, multiplexing reduces pin count, perhaps allowing the pin count of some of the embodiments of the IC and method described herein to be identical to that of conventional RTCs or RTCCs. In other embodiments, the time code receiver is inductively coupled to an antenna and requires no antenna pin on the IC. In still other embodiments, the time code receiver is configured to derive, or “harvest,” the power it needs to operate from the carrier wave that bears the information received from a time code transmitter, allowing it to operate without the need for a separate power source.

Certain embodiments of the IC and method include an input allowing the entry of localization data, such as would indicated a time zone or ZIP code. More specific embodiments also include an input allowing the entry of an indication as to whether or not to take DST into account. The IC is then configured to employ the former or both of these inputs to process data received to produce the proper time and date information for the location of the device.

According to the various embodiments illustrated and described herein, a new IC containing a time code receiver is made available for inclusion in a wide variety of devices, including embedded systems. Through the addition of this new IC, the suitably precise time from a remote time source, e.g., an atomic clock, is now made available to the device and can improve its function. The precise time also enables the device to perform functions that were impractical or would not have made sense to implement in the absence of such an IC.

FIG. 1 is a block diagram of one embodiment of a device 100, such as an embedded system, containing an IC 110 having an on-chip time code receiver 111. The IC 110 has a monolithic substrate (not shown) that is formed of silicon or any other conventional or later-developed material. The IC 110 may be fabricated by any conventional process and include bipolar transistors or field-effect transistors (FETs), including metal-oxide semiconductor FETs (MOSFETs) and complementary MOS (CMOS) semiconductors. The IC 110 may also be fabricated by any conventional or later-developed semiconductor fabrication processes and integration scale or “technology.” The time code receiver 111 is configured to receive a timing signal that contains time and frequency information. An antenna 113 is directly connected or inductively coupled to the time code receiver 111.

The illustrated embodiment of the IC 100 also has an RTC 112. The RTC 112 contains a local oscillator (e.g., a crystal oscillator) that oscillates at a nominal frequency (e.g., 32 kHz) and functions as the source of a clock signal for the IC 110 and, by extension, the device 100 as a whole.

A controller 120 is coupled to the IC 110. In the illustrated embodiment, the IC 110 is one of a plurality of chips constituting the controller 120. The illustrated embodiment of the controller 120 includes a processor 121. In more specific embodiments, the processor 121 is a microprocessor, a microcontroller, a programmable gate array (PGA) or a digital signal processor (DSP). The illustrated embodiment of the controller 120 further includes memory 122. In more specific embodiments, the memory 122 includes volatile memory such as dynamic random access memory (DRAM), static random access memory (SRAM) and non-volatile memory, such as read-only memory (ROM) or programmable ROM (PROM), often known as flash memory. Though not illustrated, the controller 120 may include other circuitry, such as custom application-specific IC (ASIC) circuitry for performing functions required in a particular application for the controller 120, such as combinatorial logic circuitry or one or more PGAs.

In addition to the IC 110, the illustrated embodiment of the device 100 contains a user interface 130 which, in the particular embodiment of FIG. 1, includes one or more user-activatable buttons 131 and a display 132. In various embodiments, the one or more buttons 131 are discrete, hardware buttons or “soft” buttons defined, perhaps intermittently, as areas of a touchscreen display. Accordingly, the display 132 may include a touchscreen display or may be a liquid crystal display (LCD), light-emitting diode (LED) display or one or more indicator lamps of any conventional or later-developed type. If the device is a vehicle, for example, the buttons 131 may include a gear shift, a turn indicator, cruise control switches, radio switches and the like, and the display 122 may include various dashboard dials, displays and indicator lights. If the device is an appliance, the buttons may include switches, momentary buttons, dials and the like, and the display 122 may include dial indicators, LCDs, indicator lights and the like. The user interface 130 may also or instead include a data port to enable a data connection to an external system or device, such as a home management system or a diagnostic computer. Those skilled in the pertinent art will understand that the user interface 130 in general may be of any configuration and combination of conventional or later-developed input or output devices.

In addition to the IC 110 and the user interface 130, the illustrated embodiment of the device 100 contains other device hardware, firmware or software 140, which may be of any conceivable conventional or later-developed type appropriate to the application or purposes of the device 100. As just a few examples, the other device hardware, firmware or software 140 may include: automotive hardware, home appliance hardware, firmware or software; business machine hardware, firmware or software; telecommunications hardware, firmware or software; timepiece hardware, firmware or software; media (audio or video) processing hardware, firmware or software; industrial control hardware, firmware or software; computer hardware, firmware or software; toy hardware, firmware or software; tool hardware, firmware or software or medical device hardware, firmware or software. Those skilled in the pertinent art will understand that the other device hardware, firmware or software 140 in general may be of any configuration and combination of conventional or later-developed hardware, firmware or software. Finally, a bus 150 couples the IC 110, the user interface 130 and the other device hardware, firmware or software 140 together, allowing them to communicate and cooperate.

As stated above, the illustrated embodiment of the time code receiver 111 is configured to receive a timing signal and generate a clock signal for the controller 120 and, by extension, the device 100 as a whole. Various embodiments of the time code receiver 111 are illustrated, described and claimed in the above-referenced co-pending and commonly owned patent application. The illustrated embodiment of the IC 110 is embodied in submicron CMOS. In the illustrated embodiment, the time code receiver 111 is embodied as a combination of hardware and software. In an alternative embodiment, the time code receiver 111 is embodied in hardware only.

In another alternative embodiment, the time code receiver 111 is embodied in software only. In a more specific embodiment, the time code receiver 111 is active only a relatively small fraction of time (i.e., has a relatively low duty cycle) and therefore execute concurrently in a processor (e.g., the processor 121) with other software that enables real-time process control, audio analog-to-digital converters (ADCs) or low-dropout (LDO) regulators or other references, just to cite three of many examples.

In the illustrated embodiment, the time code receiver 111 is autonomous of the controller 120. In an alternative embodiment, the time code receiver 111 makes at least some use of existing resources of the controller 120 110. In another alternative embodiment, the IC 110 functions other than a time code receiver 111 and an RTC 112. For example, in a specific embodiment, the IC 110 embodies an amplitude modulation (AM) radio receiver. In another specific embodiment, the IC 110 embodies a low-frequency radio receiver configured to operate on an alternative modulation scheme, such as frequency modulation (FM) or pulse code modulation (PCM).

In yet another embodiment, the IC 110 is configured to adjust other oscillators or clocks that exist in the controller 120 or in the device 100 as a whole. As those skilled in the pertinent art understand, occasional, perhaps periodic, adjustment of these oscillators or clocks based on the received phase-modulated NIST timing signal enables improved performance, the same performance with and less accurate and expensive crystal and oscillator components. For example, a function that ordinarily requires the IC 110 to have a ±20 ppm oscillator may be able to function with a ±100 ppm oscillator instead. For another example, a function that ordinarily requires the IC 110 to have a temperature-controlled oscillator may be able to function with a non-temperature-controlled oscillator instead. In both examples, the IC 110 is configured to adjust less-accurate oscillators (including that employed in the RTC 112 to improve their performance to at least acceptable levels.

In still another embodiment, the IC 110 is configured to provide a timestamp traceable to certified or authenticated (e.g., government) clock sources. As a result, the IC 110 is configured for operation in applications requiring such timestamp. In a more specific embodiment, the timestamp provided by the IC 110 is employed to verify hardware modules in the device 100 (such as the controller 120 and the user interface 120) as secure and trusted to combat fraud and hacking.

In yet still another embodiment, the time code receiver 111 is configured to receive time and frequency information from time code transmitters other than WWVB. If the one of the other time code transmitters from which the time code receiver 111 is receiving time and frequency information is less precise than the phase-modulated time signal from WWVB, the output of the IC 110 will not meet either or both of Stratum-1 qualifications. In such event, one embodiment of the IC 110 is configured to produce a clock signal that does not qualify as a Stratum-1 clock signal. Therefore, the certain embodiments are configured to act as a clock source that is less accurate than a Stratum-1 clock source in the absence of a suitable time and frequency information. In a complementary embodiment, the IC 110 is configured to produce a further signal indicating that the clock signal being produced does not qualify as a Stratum-1 clock signal.

In various other embodiments, the IC 110 is configured to support novel built-in-self-test (BIST) and diagnostic features and real-time monitoring of other resources of the controller 120, including resources that create or use time. In more specific embodiments, the BIST features include precise measurement of device direct current (DC)-parameters, such as capacitance, resistance and inductance, and alternating current (AC)-parameters, such as transistor switching speed. Device testers are conventionally required to provide accurate timing references to measure such parameters. However, device testers are rarely available where an IC may be deployed. In another embodiment, trends in frequency and time accuracy can be tracked, allowing early failure warning and detection information to be provided, to prompt repair and avoid subsequent, perhaps critical, failures.

FIG. 2 is a flow diagram of one embodiment of a method of operating an IC. The method begins in a start step 210. In a step 220, power is derived for the IC from a carrier wave that bears a timing signal. In a step 230, a time code receiver of the IC is activated. In a step 240, the timing signal is received into the time code receiver. In a step 250, an RTC is activated. In a step 260, the timing signal is employed to adjust a local oscillator of an RTC. In a step 270, the timing signal is employed in at least one of a processor and memory of a controller coupled to the IC. The method ends in an end step 280.

Those skilled in the art to which this application relates will appreciate that other and further additions, deletions, substitutions and modifications may be made to the described embodiments.

What is claimed is:

1. An integrated circuit (IC), comprising:
a monolithic substrate; and
a time code receiver supported by said monolithic substrate and configured to receive a timing signal and employ said timing signal to adjust a local oscillator of a real time clock.

2. The IC as recited in claim 1 wherein said real time clock is supported by said monolithic substrate.

3. The IC as recited in claim 1 wherein said Stratum-1 clock source is configured to make at least some use of a processor of a controller coupled to said IC.

4. The IC as recited in claim 1 wherein said IC is configured to embody functions other than a Stratum-1 clock source.

5. The IC as recited in claim 1 wherein said time code receiver is configured to be activated before said real time clock.

6. The IC as recited in claim 1 wherein said IC is configured to derive power from a carrier wave that bears said timing signal.

7. The IC as recited in claim 1 wherein said IC is configured to adjust other oscillators or clocks in said IC.

8. The IC as recited in claim 1 wherein said time code receiver is configured to receive time and frequency information from time code transmitters other than WWVB and produce a further signal indicating that said clock signal does not qualify as a Stratum-1 clock signal.

9. A method of operating an integrated circuit (IC), comprising:
receiving a phase-modulated timing signal from WWVB into a time code receiver supported by a monolithic substrate; and
employing said timing signal to adjust a local oscillator of a real time clock.

10. The method as recited in claim 9 wherein said real time clock is supported by said monolithic substrate.

11. The method as recited in claim 9 further comprising making at least some use of a processor of a controller coupled to said IC.

12. The method as recited in claim 9 further comprising embodying functions other than a Stratum-1 clock source.

13. The method as recited in claim 9 further comprising activating said time code receiver before said real time clock.

14. The method as recited in claim 9 further comprising deriving power for said IC from a carrier wave that bears said timing signal.

15. The method as recited in claim 9 further comprising employing said IC to adjust other oscillators or clocks in said IC.

16. The method as recited in claim 9 further comprising:
receiving time and frequency information from time code transmitters other than WWVB; and
producing a further signal indicating that said clock signal does not qualify as a Stratum-1 clock signal.

17. A device, comprising:
an integrated circuit (IC), including:
a monolithic substrate, and
time code receiver supported by said monolithic substrate and configured to receive a timing signal and employ said timing signal to adjust a local oscillator of a real time clock;
a controller;
a user interface;
other device hardware, firmware or software; and
a bus coupling said IC, said controller, said user interface and said other device hardware, firmware or software.

18. The device as recited in claim 17 wherein said real time clock is supported by said monolithic substrate.

19. The device as recited in claim 17 wherein said time code receiver is configured to embody functions other than a Stratum-1 clock source.

20. The device as recited in claim 17 wherein said time code receiver is configured to be activated before said real time clock.

21. The device as recited in claim 17 wherein said IC is configured to derive power from a carrier wave that bears said timing signal.

22. The device as recited in claim 17 wherein said time code receiver is configured to adjust other oscillators or clocks in said device.

23. The device as recited in claim 17 wherein said time code receiver is configured to receive time and frequency information from time code transmitters other than WWVB and produce a further signal indicating that said clock signal does not qualify as a Stratum-1 clock signal.
